(19) United States
(12) Patent Application Publication
(10) Pub. No.: US 2012/0210447 A1
(43) Pub. Date: Aug. 16, 2012

(54) Secure video download method

(76) Inventors: Pedro Javier Vazquez, Laguna Niguel, CA (US); Kucherenko Danylo, Petrozavodsk (RU)

(21) Appl. No.: 13/457,121

(22) Filed: Apr. 26, 2012

Related U.S. Application Data
(63) Continuation-in-part of application No. 13/301,451, filed on Nov. 21, 2011.
(60) Provisional application No. 61/417,448, filed on Nov. 28, 2010.

(51) Int. Cl. G06F 21/24

(52) U.S. Cl. 726/28

(57) ABSTRACT

A method of movie distribution runs on a server accessible by a user desiring to look for a movie to download. After user authentication, the server retrieves a user's permissions list from storage. When it receives a request from the user to download the movie, it checks the permissions list to determine whether or not the user has permission to download the movie. If permitted, the server watermarks the video in a process involving segmenting the video and sends an integrated stream of watermarked-video over the network. When the user does not have permission, then the server requests personal details to gain permission. The server optionally checks if the user is accessing the server from the same Internet Protocol address as used in a previous access. If not, the server asks the user to prove that the user is the same user that has permission to access the server.

### CROSS-REFERENCE TO RELATED APPLICATION

This application is a continuation-in-part of U.S. application Ser. No. 13/301,451, filed 21 Nov. 2011, which claims the benefit of U.S. Provisional Application No. 61/417,448, filed 28 Nov. 2010, all of which are hereby incorporated by reference herein.

### TECHNICAL FIELD

In the field of support for digital processing systems, a method is disclosed for processing a user request for a video download that sends the requested video denoted on-the-fly with a user-specific watermark added to a video during the download without delaying the process of downloading the video.

### BACKGROUND ART

The method set forth herein enables a user to gain access to and download movies of their choice once the movie has been marked with a user-specific digital watermark that identifies the user. The terms “video” and “movie” are used interchangeably herein and are intended to refer to an electronic digital recording of a motion picture for playing on a device capable of displaying motion picture, such as a television set, video phone, or other computer or computerized device.

A video, or video file, typically comprises frames. In filmmaking, video production, animation, and related fields, a film frame or video frame is usually one of the many still images which compose the complete moving picture. A frame is also sometimes used as a unit of time, so that a momentary event might be said to last 6 frames. The actual duration of the event depends on the frame rate of the system, which varies according to the video or film standard in use.

In the past, unauthorized copies of videos in the movie industry were hard copies on tape, such as video cassette tapes, or other portable physical media, such as DVD. While these copies remain in use, and can be copied by users with the right equipment, it was not a simple or easy copying process available to all viewers.

However, the ubiquity of high-bandwidth Internet connections has made circumvention of owner's rights a simple matter of a few clicks on computer. More and more movies are delivered today via streaming or simple download. Thus, it is a growing trend that is of presenting concerns for piracy and loss of revenue to video owners.

Internal to the movie industry, an authorized copy of an electronic video file is sometimes illicitly converted to an unauthorized version and a watermark removed by a thief. It has been reported that a large percentage of illegally shared movies are leaked by industry insiders. It has also been reported that the availability of unauthorized copies directly affects theater attendance and DVD sales, and hence represents a major financial threat to the movie industry.

While multimedia segmentation techniques embed watermarks in multimedia signals, such as images, video and audio, these techniques do not add watermarking during download, often require significant computer resources and can delay the availability of the multimedia signals well beyond practical utilization in video sales.

### SUMMARY OF INVENTION

A method of movie distribution runs on a server accessible by a user desiring to look for a movie to download. The server authenticates the user. It retrieves a user's permissions list from storage. When it receives a request from the user to download the movie, it checks the permissions list to determine whether or not the user has permission to download the movie. When the user has permission, then the server watermarks the video in a series of steps including parsing the video into one or more paired sequential segments, generating the watermark and inserting it into a short-uncompressed segment of the movie; recompressing the segment and sending a watermarked-video over the network for receipt as an integrated stream. When the user does not have permission, then the server requests that the user submit personal details to gain permission. It verifies the personal details if possible and then when the personal details are verified, it updating the permissions list to enable the user to download the video. If the personal details cannot be verified, then it refuses to permit the user to download the video.

The server may perform optional security checks when authenticating the user. When doing so, the server stores in the permissions list the Internet Protocol address of the user when the user first accesses to the server. When the user accesses the server a second time, then the server determines if the Internet Protocol address is the same. When it is not the same, the server asks the user to prove that the user is the same user that has permission to access the server.

### Technical Problem

Watermarking a video file in many locations throughout the movie is a time consuming process that is expensive to perform, requires significant computer resources, and must be done in a way to make it difficult to detect and remove the watermark. Watermarks previously applied to videos are implemented with time consuming processes. Those that minimize computer resources or expensive operations have been easily detectable and removable in the pirating process, which defeats the purpose of the watermark.

For watermarking to be an effective tool to combat piracy of files, the watermark must be small as to be virtually undetectable in all locations, inserted in such a way as to make it impractical to remove the watermark, and associated with a particular user so as to enable tracing the source of an illegal copy of the video.

Previously user-specific watermarks for each copy were so time-consuming as to be impractical for regular use. But a user-specific watermarking method that requires no significant time delay between request and receipt of the copy is needed.

Presently, watermarking methods present problems in the size in bytes required to implement a unique watermark, the time it takes to mark a video file with a mark unique to a particular user, the large amount of computer resources needed and the consequent frustration of sale due to forcing a potential video purchaser to wait for the watermarking process to complete.

There is presently a significant problem with the unauthorized use of personal data, such as stolen credit card information, to obtain content. Hacking of accounts of a trusted user by other person can also be problematic to maintaining a secure account for the authorized user. A sales and distribution system needs an automatic account block on possible unauthorized intrusion and should still be able to verify personal data to enable downloading under the blocked account.

### Solution to Problem

The solution is on-the-fly user-specific watermarking during video download. This is enabled by a method and computer that preprocesses a video to create long unmarked and compressed segments and short uncompressed segments ready for marking. When a user requests a video, a long segment begins to immediately download while the computer creates a watermark for the specific user and applies that watermark to the short uncompressed segments and then compresses the watermarked short segment in time to seamlessly append each short segment to each downloading long segment.

The system checks the credentials of a user to detect a potential problem, such as if the system suspects that there is an unauthorized use of personal data, such as stolen credit card information, or if the system suspects that a user's account has been hacked. When the system identifies a potential problem, the system employs a series of steps to verify personal data to enable downloading.

### Advantageous Effects of Invention

This system generates unique watermarked videos in real-time. In this system, video data is prepared in such a way that it becomes possible to handle many videos during multiple user requests and sending data non-stop with embedded watermarks. This is accomplished by dividing the source video file into logical pieces of long and short segments. These short segments of the file can then be used for fast generation of watermarked frames while the long segments are being downloaded. The watermarked short segments are seamlessly appended to the long segments being downloaded to the client computer to provide them with a playable and watermarked file. The method enables embedding watermarks as often as needed to make manual extraction of watermarks difficult, and not so often that it will disturb the viewer of the video.

Each copy of a video will have a user-specific watermark added at a multitude of locations throughout the video. If a copy of the work is discovered having been illegally downloaded, then the user-specific watermark could be used to determine the source of the file. On the fly watermarking enables hassle free sales of videos that are marked in such a way as to give greater assurance that unauthorized copying can be traced back to the original purchaser. Since the watermark associates the user to the downloaded video, every streamed or downloaded movie will have a virtually undetectable and hard to remove watermark. The user will not be delayed in receiving video and the time it takes to watermark the video with a unique marking is relegated to virtually unnoticeable computer operations.

In addition to fast watermarking, the advantages include a system that: ensures correct personalization of a user's account; ensures the security of accounts, prevents unauthorized usage of account by third person; remains user friendly even for customers, who want to remain anonymous (they can buy content, which does not require high permission level); classifies users to enable access to lower level content, even when users are not verified users, which maintains a balance between the availability of content for customers and needed security arrangements against fraudsters. The system has marketing advantages because it does not discourage customers who are not ready to provide their personal information, but can be placed on a permissions list for lower level content.

### BRIEF DESCRIPTION OF DRAWINGS

The drawings illustrate preferred embodiments of the method of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a block diagram of raw video pre-watermarking operations.

FIG. 2 is a block diagram of watermarking operations.

FIG. 3 is a representation of the time lines involved in downloading a video.

FIG. 4 is a block diagram of preferred steps used in the video downloading and watermarking process.

FIG. 5 is a block diagram of the components in the apparatus used to implement a preferred embodiment of the method.

FIG. 6 is an example of a portable pixel matrix.

FIG. 7 is a representation of a paired sequential segment.

FIG. 8 diagrams the steps to enable secure video download.

FIG. 9 diagrams secure video download steps performed when the user does not have permission to download a video.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. For example, the steps in the method of the invention may be performed in any order that results applying a watermark to a video during download.

A preferred method is implemented on a computer (200) connected to a network (505). It applies of a watermark (216) to a video (110), also referred to as a video file. The process is best implemented on-the-fly, that is, while the video is being downloaded. So, the video (110) to be downloaded starts out in segments: long segments that are not watermarked and short segments that are watermarked during download. The video is seamlessly assembled during download with the watermarked short segments appended to the long segments.

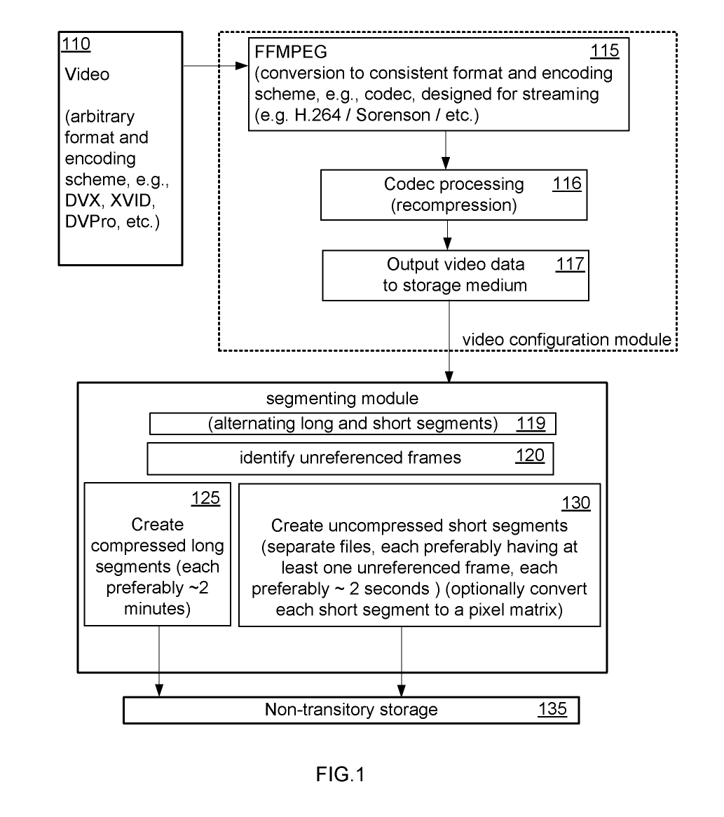

The video (110) is the source video and is in one of many formats currently used, such as MP4, MPEG and Ogg. The video (110) may be encoded with an arbitrary codec designed for streaming, such as h.264 and Sorenson. In such case the video (110) may be converted to a standard format for streaming such as FFMPEG (115) and then recompressed (116), as shown in FIG. 1.

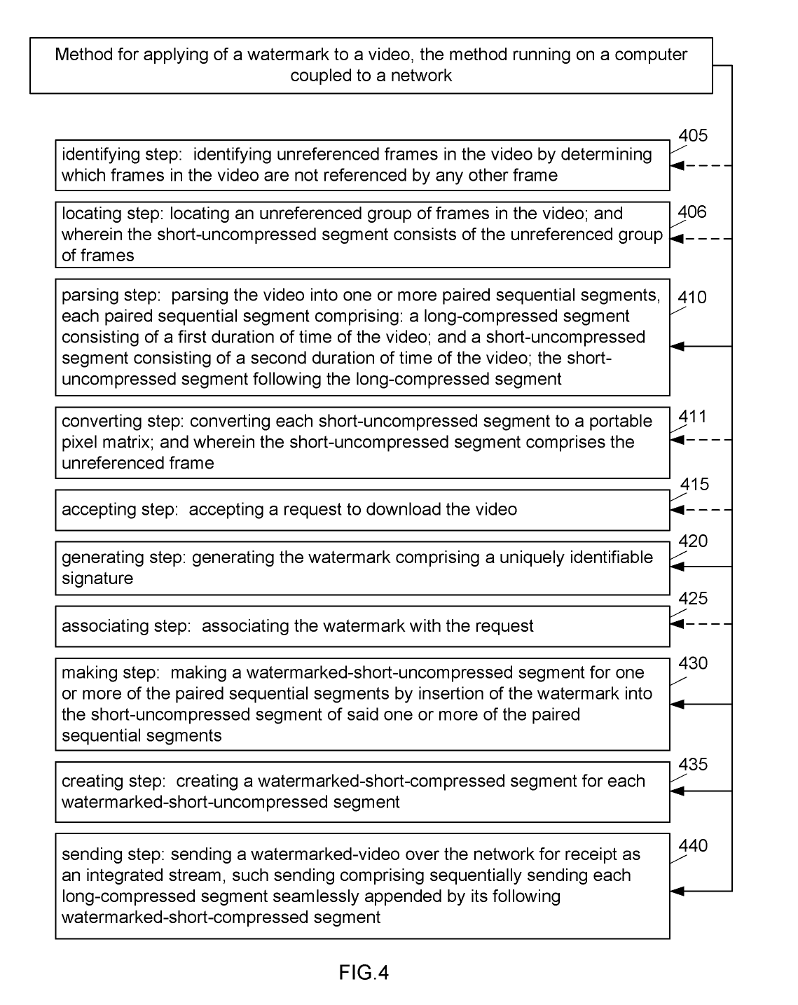

FIG. 4 shows this preferred method, which includes a parsing step (410), an accepting step (415), a generating step (420), an associating step (425), a making step (430), a creating step (435), and a sending step (440). An alternative method may include an identifying step (405).

The parsing step (410) includes parsing the video (110) into one or more paired sequential segments. Preferably there are many such paired sequential segments. However, there may be only one such paired sequential segment (705). Each paired sequential segment (705) in the plurality of paired sequential segments comprises: a long-compressed segment (315) consisting of a first duration of time of the video (110); and a short-uncompressed segment (706) consisting of a second duration of time of the video (110). The second duration of time is preferably, but not necessarily, shorter than the first duration. Thus, as used herein the term “short” is intended to be discriminator over the term “long” and also to reflect the preferred embodiment where the short segment is shorter in duration than the long segment The short-uncompressed segment (706) follows the long-compressed segment (315). Preferably, the first duration of time is about 2 minutes and the second duration of time is about 2 seconds as shown for the step of “Create compressed long segments (each preferably ˜2 minutes)” (125) as shown in FIG. 1

The method may be performed by selecting arbitrary frames within the video (110) for watermarking. However, a preferred step includes an identifying step (405), which is optional and includes identifying “unreferenced frames” (120) in the video (110) by determining which frames in the video (110) are not referenced by any other frame. This optional step is indicated by a dashed arrow in FIG. 4.

A video (110) consists of a combination of up to three kinds of frames; keyframes, P frames, and B frames. Some codecs (e.g. WebM format) may contain only I and P frames with no B frames. A keyframe contains enough information to rebuild the frame, while the P and B frames require information from neighboring frames. This means that watermarking or editing an arbitrary frame will cause modification to other frames that use the edited arbitrary frame. This problem might be solved by decoding all related frames and encoding them again, removing references to the edited frame. However, this is time consuming because multiple frames need to be edited.

Alternatively, a frame may be identified which is not referenced by other frames. In some codecs, frame sequences are separated by frames called IDR frames. In other codecs, frame sequences are separated by frames having another name. (e.g., in MPEG such frames are termed an “I-frames”). For simplicity, any such frame is referred to herein as an IDR frame.

Any frame after an IDR frame cannot reference a frame before the IDR frame in a decoded segment. So the segment would start with an IDR frame and end with an IDR frame, with no IDR frames in between. In encoding, display-order differs from decoding order. The last frame in some sequence with regards to display-order may not be the last in decoding order. Thus, if one edited the decoded frame just before the IDR frame (in decoding order), it would not affect any frames before it (because they can't reference it since they will have been decoded before decoding this frame), and any frames after it can't reference it because the frames are separated by an IDR frame. This is a simpler and preferable approach because there is no need to re-encode the video stream for deletion of references to the edited frame.

It is rare to find two nearby frames that are not referenced by some other frame. This is because the video compression programs typically use references between nearby frames to minimize size in bytes to store information about similar pictures. It is possible, however, to identify groups of frames and find that any one group of frames is not referenced by frames in other groups. So, for example, a group of frames bounded by IDR frames, including first IDR frame and excluding second IDR frame will be an unreferenced group of frames. For such group of frames, the watermark is added to each frame in such group so that all frames become watermarked and re-encoded. For this embodiment, the method includes a locating step (406), which is a step of locating an unreferenced group of frames in the video and, once located, the short-uncompressed segment consists of that unreferenced group of frames. This optional step is indicated by a dashed arrow in FIG. 4.

Optionally, the method includes a converting step (411), which is a step of converting each short-uncompressed segment (706) to a portable pixel matrix (610), also known as a portable pixel map. This optional step is indicated by a dashed arrow in FIG. 4. For example, such conversion may be implemented by having each short segment further segmented into separate files and converted to a pixel matrix. A pixel matrix is a lowest common denominator format (reference ppm definition format, updated Oct. 3, 2003, at website netpbm.sourceforge.net/doc/ppm.html).

Optionally, the method includes an accepting step (415), which is “accepting a request” (205) to download the video (110), which is caused by receipt of a request (204) accepted by the computer. This optional step is indicated by a dashed arrow in FIG. 4. When performed, the accepting step (415), results in a computer internal command of “requesting watermark of short segments” (206).

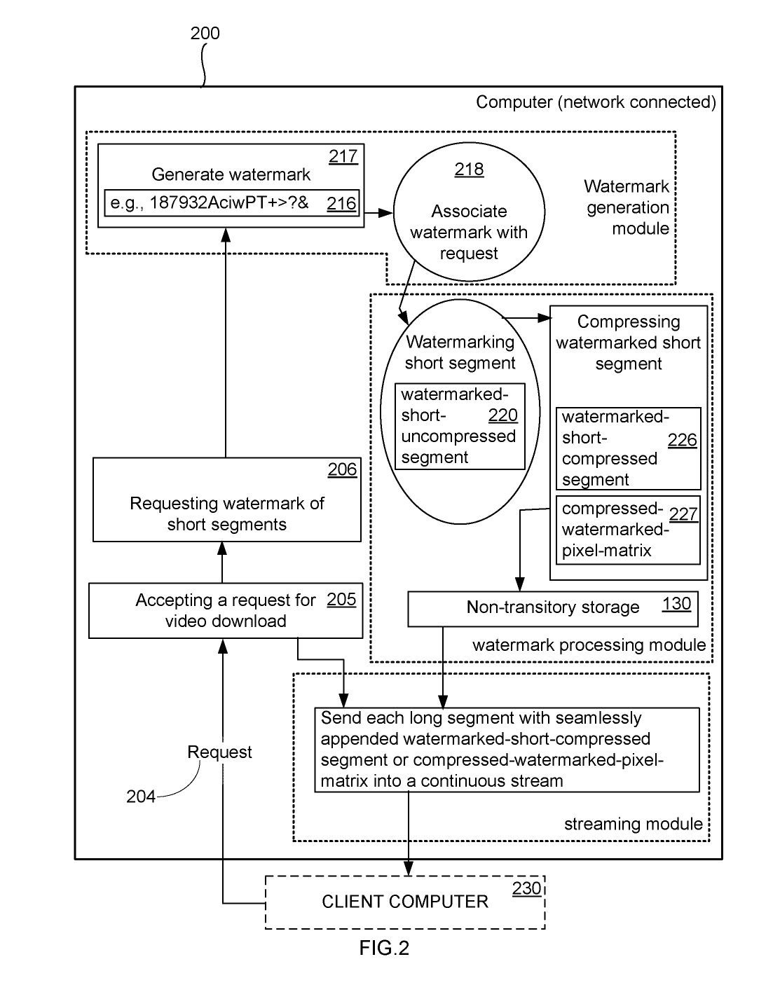

The generating step (420) includes generating the watermark (216) comprising a uniquely identifiable signature. The uniquely identifiable signature is preferably a randomly-generated alphanumeric string, but may be any other unique symbol such as a graphic image. An alphanumeric string is shown as “Generate watermark” (217) in FIG. 2, which shows a randomly-generated unique 16-character string. Such a string may include any alphanumeric character.

When the accepting step (415) is included, then the method optionally includes an associating step (425), which is associating the watermark (216) with the request (204). This associating step (425) is optional and is indicated by a dashed arrow in FIG. 4. It is also illustrated in FIG. 2 as “Associate watermark with request” (218). Association of the uniquely identifiable signature with the requestor ties the watermark to a specific user download.

The making step (430) includes making a watermarked-short-uncompressed segment (220) for one or more paired sequential segment (705) by insertion of the watermark (216) into the short-uncompressed segment (706) of said one or more of the paired sequential segments. The use of “one or more” in this step is intentional because when there is more than one paired sequential segment, not all of the short-uncompressed segments (706) in paired sequential segments need be watermarked; though it would be preferably if all were watermarked. When the optional step of identifying unreferenced frames is performed, then the watermark (216) is inserted into the unreferenced frame of one or more short-uncompressed segments.

The creating step (435) includes creating a watermarked-short-compressed segment (226) for each watermarked-short-uncompressed segment (220).

The sending step (440) includes sending a watermarked-video (330) over the network (505) for receipt as an integrated stream. The sending step (440) is implemented by sequentially sending each long-compressed segment (315) seamlessly appended by the following watermarked-short-compressed segment (226).

Thus, in a preferred process, when a user requests a video file, a compressed portion of the video is downloaded. While the compressed portion of the video is being downloaded, the watermark is embedded on the uncompressed pixel matrix and it is compressed and merged into the compressed video. This process repeats until the entire video is downloaded. From the client's standpoint, he or she is receiving a solid compressed video file. In one or more embodiments, this watermark is put onto the file as it is being burned onto a DVD as part of the download. In another embodiment, this can be done while a video is streaming to a player on the client computer.

In another embodiment, as the frame to be watermarked is determined, it is noted where the frames to be watermarked are. Then as the video is being streamed, the frames to be watermarked are extracted, watermarked, and reinserted.

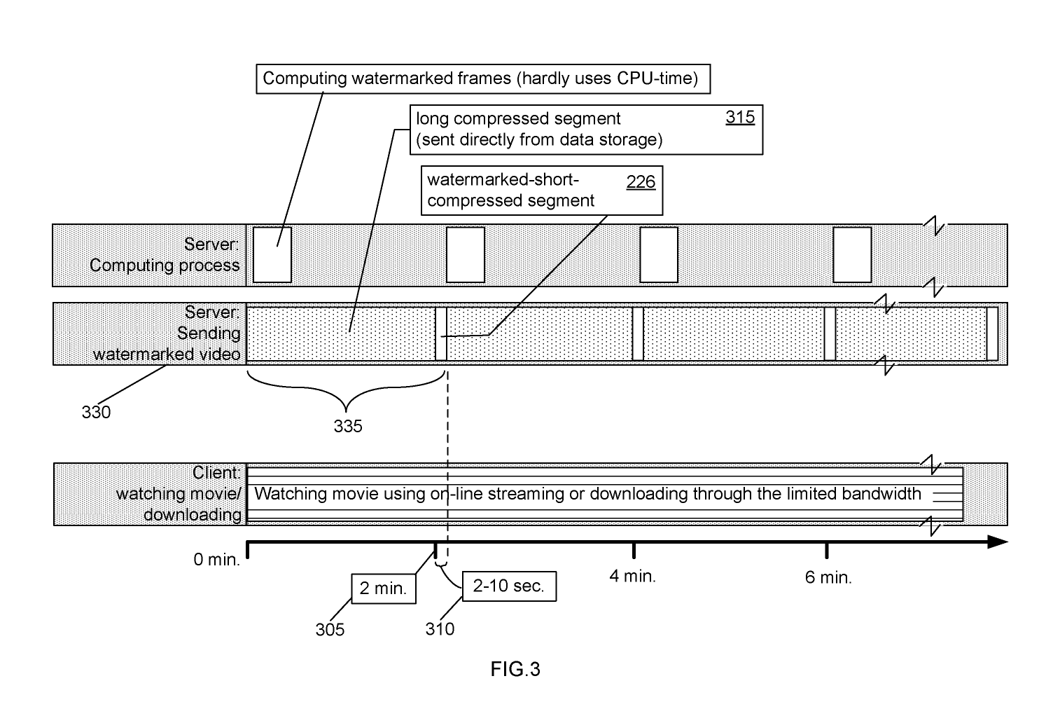

FIG. 3 illustrates the timeline of the downloading process, which is simply repeated in parallel when watermarking multiple video files for multiple download requests. For a single user, the server can send a small portion of the file (long-compressed-segment (315)) while a second module on the server creates the watermarked-short-compressed segment (226). By the time the compressed data is sent to the user, the uncompressed frames have been watermarked and compressed and can then be sent to the client. Because the time for computing the watermarked frames and compressing them is small, multiple users can be handled at the same time.

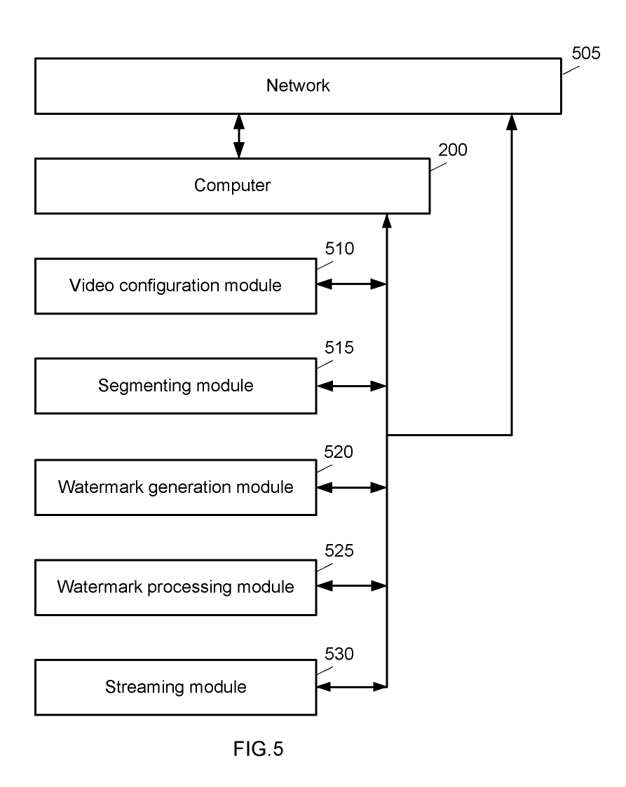

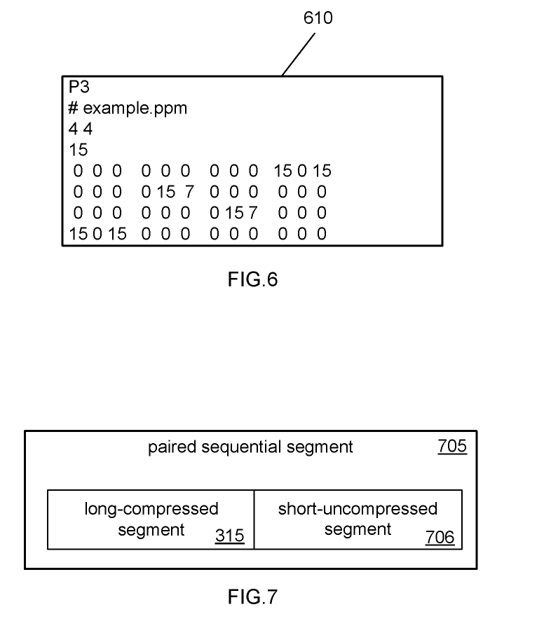

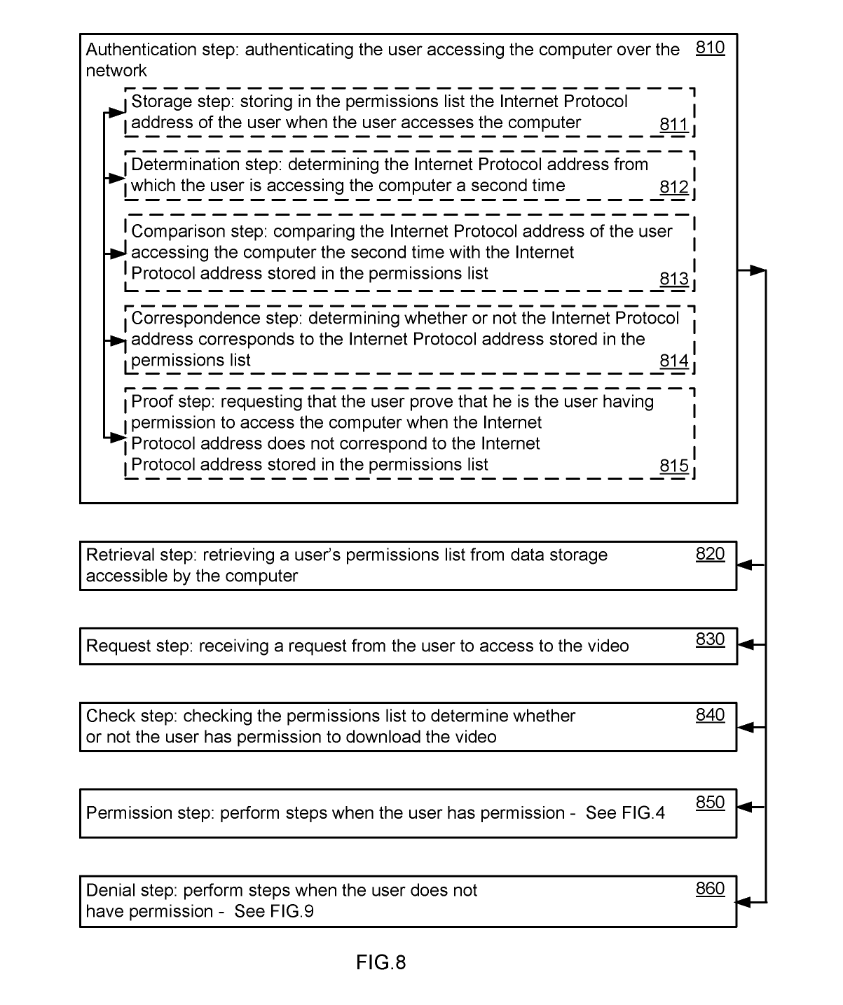

As shown in FIG. 5, the preferred computer for applying of the watermark (216) to a video (110) is coupled to a network (505), such as the Internet, for example to interact with users who may request a video (110). The computer may be a single device, but is preferably comprised of separate computers or modules programmed to, or operable to, perform the steps of the method. The modules also may be integrated in a single computer or be physically separate and connected to a central computer or server either directly or through the network (505). The modules include: a video configuration module (510), a segmenting module (515), a watermark generation module (520), a watermark processing module (525) and a streaming module (530).

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

The video configuration module (510) is operable to: accept a video (110) in an arbitrary format and encoding scheme and convert the video (110) to a consistent format and encoding scheme. In one or more embodiments, MP4 and h.264 is used as the consistent format and encoding scheme. In one or more embodiments, FFMPEG is used to convert arbitrary format and encoding scheme to MP4/h.264. FFMPEG is a free software project that produces libraries and programs for handling multimedia data. During the conversion to the arbitrary format, the video is re-compressed by the video configuration module (510).

The segmenting module (515) is operable to: identify unreferenced frames in the video (110) and segment the video (110) into one or more segments. These segments are alternating long and short segments (119), that is, a first long segment followed in sequence by a first short segment immediately followed by a second long segment which is followed in sequence by a second short segment, and so on. Each short segment preferably includes an unreferenced frame.

As shown in FIG. 2, the segmenting module (515) extracts each short-uncompressed segment (706) to a separate file. The segmenting module (515) may be further operable to convert each short segment to a portable pixel matrix (610). The temporal relationship between the segments is maintained in the non-transitory storage (130).

The segmenting module (515) stores single compressed files of long segments and single uncompressed short segments; the short segments optionally in uncompressed pixel matrices. Information about the proper order of segmentation may be stored in a data registry. In one or more embodiments, the data registry stores a pair of values, where the pair is a combination of the packet position of the required frame and the frame number. The package position is the offset in bytes from the beginning of the frame sequence. The frame number is the index of the frame in display order within the frame sequence. In one or more embodiments, the data registry can use any structured data to store it such as a database or structured text file.

The watermark generation module (520) is operable to: generate the watermark (216). It also optionally associates the watermark (216) with a specific download process.

The watermark processing module (525) is operable to: create a watermarked-short-compressed segment (226) by adding the watermark (216) to the unreferenced frame in one or more of the short segments; compress each watermarked-short-uncompressed segment (220) to create a watermarked-short-compressed segment (226); and store the watermarked-short-compressed segment (226) so as to be available for downloading.

The streaming module (530) is operable to seamlessly send each long-compressed-segment (315) and each compressed-watermarked-pixel-matrix (227) to a client computer (230) upon a request (204) to download the video (110). Upon completion of a compressed segment (335), the module repeats the process until the entire watermarked video (330) is downloaded.

An embodiment of the device consists of a collection of servers, each consisting of one or more computers connected to a network, each computer having one or more storage devices and one or more interactive input devices. These input devices may include but are not limited to a mouse, keyboard and webcam. The device is configured to connect with a client computer over a network. The client computer contains a program which will either play the compressed file or burn the compressed file onto a DVD.

The apparatus may alternatively be described as a non-transitory computer readable storage medium having stored thereon programming instructions that, when executed by a computer (200) coupled to a network (505), cause the computer (200) to perform a method for applying of a watermark (216) to a video (110) file. The non-transitory computer readable storage medium is an article of manufacture, such as network attached storage (NAS), read-only memory, random-access memory, CD-ROM disk, optical disk, a floppy drive, CD-R, CD-RW, DVD, flash drive, magnetic tapes, and other optical and non-optical data storage devices, and is not a transitory propagating signal per se.

The method performed by these programming instructions includes a step of segmenting the video (110) file into a plurality of alternating long compressed segments and short uncompressed segments. Each long compressed segment is preferably approximately 2 minutes of video (110), as is shown in FIG. 3 as “2 min.” (305). Each short uncompressed segment is preferably translates to about 2 to 10 seconds of watermarked-short-compressed segment (226), as shown in FIG. 3 as “2-10 sec.” (310). Each short uncompressed segment is at least one frame organized in a portable pixel matrix (610).

The method performed by these programming instructions optionally includes a step of “accepting a request” (205) to download the video (110) file.

The method performed by these programming instructions further includes a step of generating a watermark (216).

The method performed by these programming instructions further includes a step of placing the watermark (216) into the portable pixel matrix (610) of one or more of the short uncompressed segments to create a watermarked-pixel-matrix.

The method performed by these programming instructions further includes a step of compressing the short uncompressed segments, forming at least one compressed-watermarked-pixel-matrix (227).

The method performed by these programming instructions further includes a step of streaming seamlessly each long compressed segment and each compressed-watermarked-pixel-matrix (227) in response to the request (204).

Secure Video Download Method

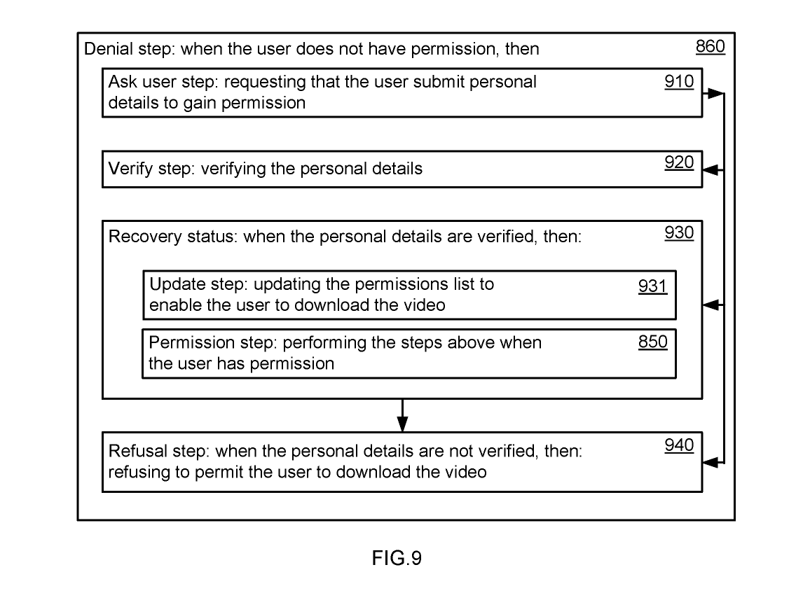

FIG. 8 and FIG. 9 illustrate a preferred method of movie or video download or distribution that runs on a server, or computer coupled to a network. The computer includes non-transitory computer readable medium, which is also referred to herein as non-transitory storage (135) on which is stored instructions for enabling a user accessing the server to download a video. These instructions when executed on the computer cause the computer to perform steps including: an authentication step (810) involving authenticating the user accessing the computer over a network. The user accesses the server using a client device. When the user first accesses the computer, the computer implements a retrieval step (820) and retrieves a user's permissions list from data storage accessible by the computer. Such data storage may be a database or other file stored on a non-transitory storage medium at any location.

Authentication step (810) may include an enhanced security protocol that double checks on the user's credentials. Thus the authentication step (810) may include five additional steps, which are indicated in dashed boxes to show that these are optional steps.

Of the five additional steps, the authentication step (810) may include a storage step (811) of storing in the permissions list the Internet Protocol address of the user when the user accesses to the computer. The Internet Protocol address of the user may vary because of the user's access from different computers, such as at home or at work. In that case, more than one Internet Protocol address will be stored in the permissions list.

Of the five additional steps, the authentication step (810) may include a determination step (812) of determining the Internet Protocol address from which the user is accessing the computer a second time.

Of the five additional steps, the authentication step (810) may include a comparison step (813) of comparing the Internet Protocol address of the user accessing the computer a second time with the Internet Protocol address stored in the permissions list. If there is more than one such Internet Protocol address stored in the permissions list, then correspondence may be with any of those stored.

Of the five additional steps, the authentication step (810) may include a correspondence step (814) determining whether or not the Internet Protocol address corresponds with the Internet Protocol address stored in the permissions list. Such correspondence may include checking whether or not the user's Internet Protocol address belongs to same city and/or same Internet service provider.

Of the five additional steps, the authentication step (810) may include a proof step (815) of requesting that the user prove that he is the user having permission to access the computer when the Internet Protocol address does not correspond to the Internet Protocol address stored in the permissions list. When more than one Internet Protocol address is stored in the permissions list, then all that are stored for that user are checked for such correspondence.

Usually after the user signs on and is authenticated, the user may find a movie or video file that the user wants to download and view. The user indicates to the computer that the user wants a selected movie, which would typically be by the user clicking on a download button. Thus, the computer implements the request step (830) of receiving a request from the user to access to the video.

If the user had previously entered personal information, which was verified by Verify step (920), then the user's status indicating his trusted level would be recorded in the permissions list. If user had a trusted level record and no black-list flags, then the user would be allowed to download higher level content. Black-list flags would be stored in a user's history, when there is detected illegal sharing of content or suspicious actions, such as an attempt to buy from credit cards with different cardholder names. Such an attempt would tend to indicate that user might be a fraudster having details of third party person's credit cards. The flags would be stored in permission list as a “negative record.”

The computer, thus, checks the permissions list to detect the user's allowed content level and to confirm that the user is not black-listed for any reason, and thus implements a check step (840) of checking the permissions list to determine whether or not the user has permission to download video requested in the request step (830).

When the user has permission, then the computer implements a permissions step (850), which are the steps described above and shown in FIG. 4. While the description of these steps is not repeated in detail at this point, they include a parsing step (410), an accepting step (415), a generating step (420), an associating step (425), a making step (430), a creating step (435), and a sending step (440), as each of these steps is described in detail above.

When the user does not have permission, then the computer implements a denial step (860), which includes steps shown in FIG. 9.

The denial step (860) includes an ask user step (910) of requesting that the user submit personal details to gain permission. Personal details may be, for example, the user's credit card information or mobile phone number.

The denial step (860) includes a verify step (920) of verifying the personal details. For example, the user may be requested to report an amount drawn from credit card or code sent to mobile phone by SMS, which provides verification, or at least greater assurance, that the user is the real owner of submitted personal details.

The denial step (860) includes a recovery status (930) that applies when the personal details are verified, which in turn leads to an update step (931) of updating the permissions list to enable the user to download the video and a permissions step (850) of performing the steps above when the user has permission.

The denial step (860) includes a refusal step (940), which is implemented when the personal details are not verified. The refusal step (940) involves refusing to permit the user to download the video.

The terms “computer” and “server” are used interchangeably herein. While a server is a special kind of computer, it is nevertheless, a computer in a network that is used to provide services, which in this case are movie download services for other computers in the network. Embodiments of the invention as described can be implemented in digital electronic circuitry, or in computer hardware, firmware, software, or in any combination thereof.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as creating, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of MICROSOFT WINDOWS, APPLE MAC, UNIX/X-WINDOWS, LINUX, etc., executing in a virtualized or non-virtualized environment, using any programming language suitable for desktop software development.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the movie industry.

What is claimed is:

1. A method of video distribution, the method running on a computer coupled to a network, the computer comprising a non-transitory computer readable medium storing instructions for enabling a user to download a video with a watermark, the instructions when executed on the computer cause the computer to perform steps comprising:
authenticating the user accessing the computer over the network;
retrieving a user's permissions list from data storage accessible by the computer;
receiving a request from the user to access to the video;
checking the permissions list to determine whether or not the user has permission to download the video;
when the user has permission, then:
parsing the video into one or more paired sequential segments, each paired sequential segment comprising:
a long-compressed segment consisting of a first duration of time of the video;
a short-uncompressed segment consisting of a second duration of time of the video;
the short-uncompressed segment following the long-compressed segment;
generating the watermark comprising a uniquely identifiable signature;
making a watermarked-short-uncompressed segment for one or more of the paired sequential segments by insertion of the watermark into the short-uncompressed segment of said one or more of the paired sequential segments;
creating a watermarked-short-compressed segment for each watermarked-short-uncompressed segment; and
sending a watermarked-video over the network for receipt as an integrated stream, such sending comprising sequentially sending each long-compressed segment seamlessly appended by its following watermarked-short-compressed segment;
when the user does not have permission, then:
requesting that the user submit personal details to gain permission;
verifying the personal details;
when the personal details are verified, then:
updating the permissions list to enable the user to download the video; and
performing the steps above when the user has permission; and
when the personal details are not verified, then refusing to permit the user to download the video.

2. The method of video distribution of claim 1, wherein the step of authenticating the user comprising the steps of:
storing in the permissions list an Internet Protocol address of the user when the user accesses the computer;
determining the Internet Protocol address from which the user is accessing the computer a second time;
comparing the Internet Protocol address of the user accessing the computer the second time with the Internet Protocol address stored in the permissions list;
determining whether or not the Internet Protocol address corresponds to the Internet Protocol address stored in the permissions list; and
requesting that the user prove that he is the user having permission to access the computer when the Internet Protocol address does not correspond to the Internet Protocol address stored in the permissions list.
